(19) United States
(12) Patent Application Publication
(10) Pub. No.: US 2009/0306934 A1
(43) Pub. Date: Dec. 10, 2009

(54) Instrument monitoring system

(75) Inventors: Sudhanshu Gakhar, Neenah, WI (US); Joel P. Anderson, Appleton, WI (US); Richard Timmers, Bear, DE (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 12/156,912

(22) Filed: Jun. 4, 2008

(51) Int. Cl. G06F 11/30

(52) U.S. Cl. 702/182

(57) ABSTRACT

An instrument monitoring system comprises a monitoring device including a sensor for measuring an instrument and a control unit, where the control unit includes a data flow microcontroller processor; a wireless transmitter configured to receive a data signal from the monitoring device and to transmit the data signal using a wireless data transmission protocol; a wireless reader capable of receiving the data signal from the wireless transmitter; a computing device in communication with the wireless reader, where the computing device includes software configured to present the data signal as user-readable data; and a computer-readable storage medium in communication with the computing device, wherein the computer-readable storage medium is capable of storing the data.

### BACKGROUND

Like most complex electromechanical devices, healthcare equipment such as ventilators and infusion pumps often require battery power, frequent calibration, and periodic maintenance. These parameters must be carefully monitored to be certain that the equipment is fit for use, and they become even more important during times of emergency. The current method to query the “health” of such an instrument (e.g. calibration, battery life, state of maintenance) is to visit the location where the instrument is residing and manually assess the condition. This process is often time-consuming and requires physical human interaction with each individual piece of equipment. In addition, one must travel from location to location to interact with each piece of equipment, and such interactions may occasionally be inaccurate due to natural human error. Thus, there is a need for an electrical device which will attach to the instrument, query its state of health, and transmit the resulting data wirelessly to a central remote host station.

In addition to tracking the health of instruments, there is a need to track the status of the instruments to allow for automatic selection to optimize efficiency and reduce costs. For instance, when there are multiple instruments using batteries for example, knowledge of the battery status (e.g., last recharge, age of battery, or other indicators related to status) would be desirable to ensure that the instrument designated for use has a suitable charge for the task at hand. Likewise, knowing the status of the instrument itself (e.g., maintenance schedule, last calibration, general functionality, time of last use, total time of use, etc.) is also desirable to ensure that a properly working and calibrated instrument is selected, particularly in times of emergency. Thus, there is a need for a system which provides knowledge of various operational/functional parameters for an instrument in various settings, such as a healthcare setting. In addition, there is further need for a system which can help maintain (e.g., determine maintenance schedules) for such instruments.

It is also desirable that data collected for such instruments can be tied to scheduling of procedures or other activities involving the tracked instruments. For example, in a hospital setting, before a doctor begins a surgery, he or she may desire a system which can ensure that an instrument is selected having adequate battery life, proper calibration, and proper operational functionality for the procedure. Rescheduling may be needed if suitable resources are not available. Having an instrument fail prior to the end of a procedure could be disastrous, and indeed even fatal. Such scheduling may be correlated with instrument status to ensure that any further preparation (e.g., recharging, calibration, maintenance, etc.) is completed prior to the procedure, or that an additional power source or backup instruments are available if needed. Thus, there is a need for a system which can tie the data collected to the scheduling of an instrument's use or other activities involving the tracked instruments.

In addition, there is a need for a system that can be used to improve relationships with third parties (e.g., insurers) and possibly reduce rates or costs, or be used as a selling point for a business, such as a healthcare facility. For example, such a system could help patients understand that they are more likely to receive good care at a particular facility. The system could also be used to identify instruments that are used at less than an optimal level, allowing reconsideration of equipment needs.

### SUMMARY

In response to the needs discussed above, an instrument monitoring system of the present invention comprises a monitoring device comprising a sensor for measuring an instrument and a control unit, wherein the control unit includes a data flow microcontroller processor; a wireless transmitter configured to receive a data signal from the monitoring device and to transmit the data signal using a wireless data transmission protocol; a wireless reader capable of receiving the data signal from the wireless transmitter; a computing device in communication with the wireless reader, wherein the computing device includes software configured to present the data signal as user-readable data; and a computer-readable storage medium in communication with the computing device, wherein the computer-readable storage medium is capable of storing the data. In some aspects, the control unit further includes an analog/digital converter.

In some aspects of the invention, the monitoring device is attached to the instrument. In other aspects, the monitoring device is configured to measure at least one instrument parameter. In further aspects, the computing device is configured to execute instructions embodied in the computer-readable storage medium based on a response model.

In some aspects, the instrument monitoring system includes a proximity detection system capable of determining the location of the instrument. In other aspects, the system comprises multiple monitoring devices and a single computing device.

In some aspects, the instrument is a healthcare instrument. In other aspects, the data relates to an instrument parameter. In further aspects, the instrument parameter is a healthcare instrument parameter. In still other aspects, the instrument parameter does not include battery health.

In some aspects, the wireless transmission protocol is Zigbee. In other aspects, the software is capable of analyzing the data.

In some aspects, the wireless transmitter includes an antenna. In other aspects, the wireless reader includes an antenna.

In some aspects of the invention, a healthcare instrument monitoring system comprises a monitoring device comprising a sensor and a control unit, where the sensor is configured to collect information relating to at least one healthcare instrument parameter, where the control unit comprises an analog/digital converter in communication with the sensor configured to convert an analog signal from the sensor to a digital signal, and where the control unit further comprises a data flow microcontroller processor in communication with the analog/digital converter configured to control the flow of the data signal; a wireless transmitter configured to receive the data signal from the monitoring device and to transmit the data signal using a wireless data transmission protocol; a wireless reader capable of receiving and reading the data signal from the wireless transmitter; a computing device in communication with the wireless reader, we're the computing device includes software capable of presenting the data signal as user-readable data; and a computer-readable storage medium in communication with the computing device capable of storing data, where the computing device can access the data stored onto the computer-readable storage medium.

In some aspects, the software is capable of analyzing the data. In other aspects, the instrument monitoring system further comprises a response model.

In some aspects of the invention, a method for monitoring a healthcare instrument comprises: (a) providing a monitoring device configured to collect data relating to at least one parameter of a healthcare instrument; (b) connecting the monitoring device to the healthcare instrument to obtain an instrument parameter data signal; (c) transferring the data signal from the monitoring device to a wireless transmitter; (d) wirelessly transmitting the data signal from the wireless transmitter to a wireless reader using a wireless transmission protocol; (e) transferring the data signal from the wireless reader to a computing device comprising software capable of analyzing the data signal; (f) analyzing the data signal to provide analyzed data; (g) performing an action based on the analyzed data using a response model; and (h) updating the instrument parameter in a database stored on a computer-readable storage medium.

In some aspects, the method further comprises comparing the analyzed data to a historical database. Some aspects, the wireless transmission protocol is ZigBee.

In some aspects, the method includes detecting the proximity of the healthcare instrument using a proximity detection system.

Numerous other features and advantages of the present invention will appear from the following description. In the description, reference is made to exemplary embodiments of the invention. Such embodiments do not represent the full scope of the invention. Reference should therefore be made to the claims herein for interpreting the full scope of the invention.

### FIGURES

The foregoing and other features, aspects and advantages of the present invention will become better understood with regard to the following description, appended claims and accompanying drawings where:

FIG. 1 is a block diagram illustrating one aspect of an instrument monitoring system of the present invention;

FIG. 2 is a schematic of one embodiment of a sensor which includes a wheat-stone bridge circuit according to the invention;

FIG. 3 is a schematic of one embodiment of an analog/digital converter according to the invention;

FIG. 4 is a diagrammatic representation of an instrument monitoring system of the present invention which can monitor multiple instruments;

FIG. 5 is a flow diagram of one embodiment of a response model according to the present invention; and

FIG. 6 is a block diagram illustrating one aspect of a proximity detection system.

Repeated use of reference characters in the present specification and drawings is intended to represent the same or analogous features or elements of the present invention.

### Definitions

It should be noted that, when employed in the present disclosure, the terms “comprises,” “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The term “health” when used in reference to an instrument refers to the state or condition of the instrument based on measuring an instrument parameter.

The term “healthcare” refers to a setting or facility which provides health-related services and has at least one healthcare instrument, including but not limited to hospitals, medical clinics, senior-care facilities, child-care facilities, veterinary clinics, emergency response vehicles, and the like.

The term “healthcare instrument” refers to an instrument utilized in a healthcare setting. Examples of healthcare instruments include, but are not limited to, defibrillators, EKG units, infusion pumps, ventilators, ECG, EEG, and the like.

As used herein, the term “instrument” refers to any electrical instrument, device, object, and the like that is capable of being sensed by a monitoring device of the present invention.

The term “instrument parameter” refers to a measurable parameter of an instrument, including but not limited to calibration, power life, state of maintenance, maintenance schedule, last calibration, general functionality, time of last use, total time of use, age, and the like.

These terms may be defined with additional language in the remaining portions of the specification.

### DETAILED DESCRIPTION

An instrument tracking system is presented herein. In addition, a method of tracking instruments is also presented.

Like most complex electromechanical devices, instruments, such as healthcare-related instruments (e.g., ventilators, infusion pumps, and the like) for example, may require electrical power, periodic maintenance and frequent calibration, among other things. These parameters must be carefully monitored to ensure that the equipment is fit for use. The current method to query the health of such instruments is to physically visit the location where an instrument resides and to manually measure or assess the desired parameters. The present invention is directed to an instrument monitoring system which, in some aspects, can attach to one or more such instruments, query the state of health of each instrument, and then transmit the data wirelessly to a central computing device where the data can be stored and/or analyzed.

In addition to tracking the health of such instruments, some aspects of the present invention can track the instrument status to allow for automatic selection of the proper instrument for a task, to optimize efficiency, and/or to reduce costs. For example, when there are multiple instruments using batteries, the power supply status (e.g., last recharge, age of battery, or other indicators related to status) can be used to ensure that an instrument is selected having a suitable charge status for the task at hand. In another example, knowledge of the instrument status itself (e.g., maintenance schedule, last calibration, general functionality, time of last use, total time of use, etc.) may also be desirable to ensure that a properly working and calibrated instrument is selected, particularly in times of emergency.

In some aspects, the system of the present invention can be used to improve maintenance schedules for instruments. In the example of batteries, a power supply monitoring device can be associated with the batteries. For instance, such power supply monitoring device can be in electrical contact with the positive and negative terminals of the battery and can measure various desired parameters, such as voltage.

If desired, an instrument parameter may be measured continuously, while in other aspects, the instrument parameter may be measured periodically (rather than continuously) to reduce the risk of added drain on the power source for the system. In desirable aspects, the measurement of a particular instrument parameter can be transmitted wirelessly to a computing device via wireless transmitter and wireless reader that can update the status of the instrument parameter to a database of information pertaining to the parameter.

To gain a better understanding of the present invention, the following description is provided. For exemplary purposes only, some aspects of the description may focus on healthcare instruments. However, it is understood that the present invention is suitable for use with instruments in various other fields or industries as well, without departing from the scope of the present invention.

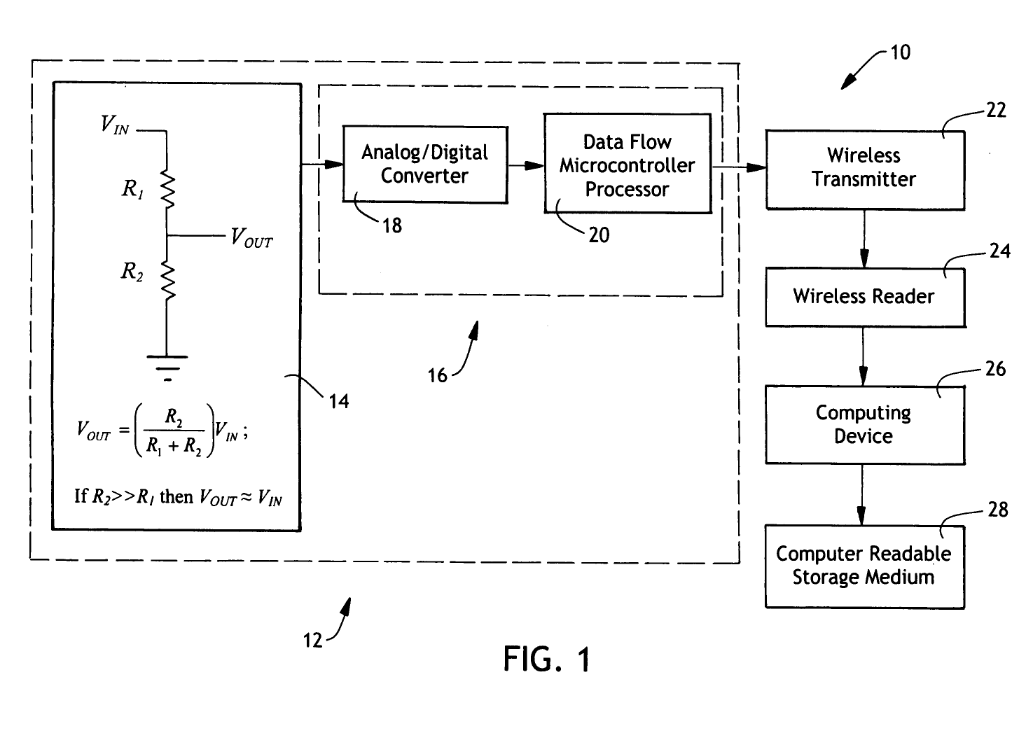

To gain a better understanding of the invention, reference is made to FIG. 1. More particularly, FIG. 1 is a block flow diagram of an instrument monitoring system 10 of the present invention. A monitoring device 12 is shown which is in contact with a desired instrument, such as a healthcare instrument (not shown). In some aspects, the monitoring device can be attached to the instrument; in other aspects, the monitoring device may be in relative proximity to the instrument; in still other aspects, the monitoring device may be integrated into the instrument. The monitoring device 12 includes a sensor 14 and a control unit 16. In some aspects, the sensor 14 is desirably electrically connected to the instrument and is in communication with the control unit 16. The control unit 16 includes a data flow microcontroller processor 20 and an optional analog/digital converter 18. If present, the converter 18 is capable of receiving an analog signal comprising instrument parameter data from the sensor 14, and then converting the analog signal into a digital signal. The digital signal is then communicated by the converter 18 to the data flow microcontroller processor 20. In other aspects, the sensor 14 provides a digital signal directly to the data flow microcontroller processor 20, without the need for an analog/digital converter 18.

The data flow microcontroller processor 20 communicates the digital signal (which contains instrument parameter data) to a wireless transmitter 22. The flow of the data is regulated by the data flow microcontroller processor 20, which may be optimized as desired.

Once the wireless transmitter 22 has received the data signal from the monitoring device 12, it can transmit the data to a wireless reader 24 using a desired wireless data transmission protocol. The wireless reader 24 can then communicate the data signal to a computing device 26 where the data signal can be converted into user-readable data. In some aspects, the data can be analyzed via software as desired. In additional aspects, the data can be stored on a computer-readable storage medium 28. This step may be performed for a variety of reasons, such as for logging purposes, potential further analysis such as with past or future data, and the like.

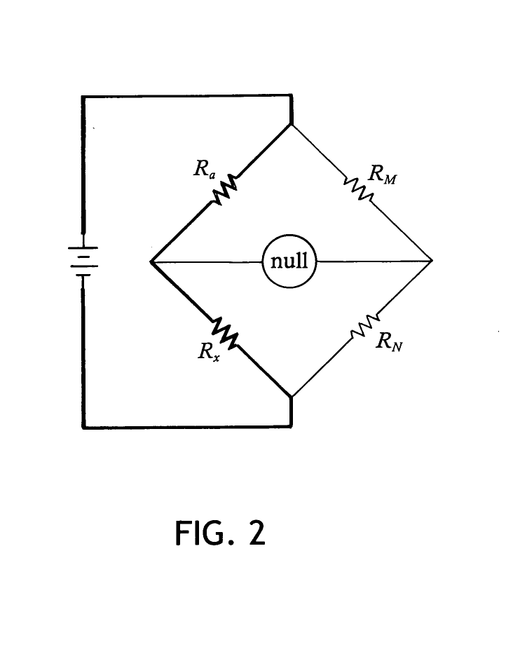

As referenced above, the monitoring device of the present invention includes a sensor and a control unit. A simplified version of a sensor is shown in the FIG. 2. Suitable sensors for the present invention include any sensor which can read, measure and/or provide desired instrument parameter data. For example, various types of sensors employing electrical, optical, acoustical, chemical, electrochemical, or other scientific principles for detecting parameters can be utilized in a monitoring device of the present invention. In some aspects, the monitoring device can be miniaturized to function as a microsensor. In other aspects, the monitoring device can include multiple sensing elements or other technologies to detect multiple instrument parameters. Suitable sensors can include a current clamp circuit and a wheat-stone bridge circuit for instance, such as the sensor 100 exemplified in FIG. 2, to measure current and voltage usage respectively. Another example of a suitable sensor could be a temperature sensor such as ADT 75 manufactured by Analog Devices Inc. (having a place of business in Norwood, Mass., U.S.A.). In some aspects, the sensor provides an analog data signal. In other aspects, the sensor may be a digital sensor which provides a digital data signal.

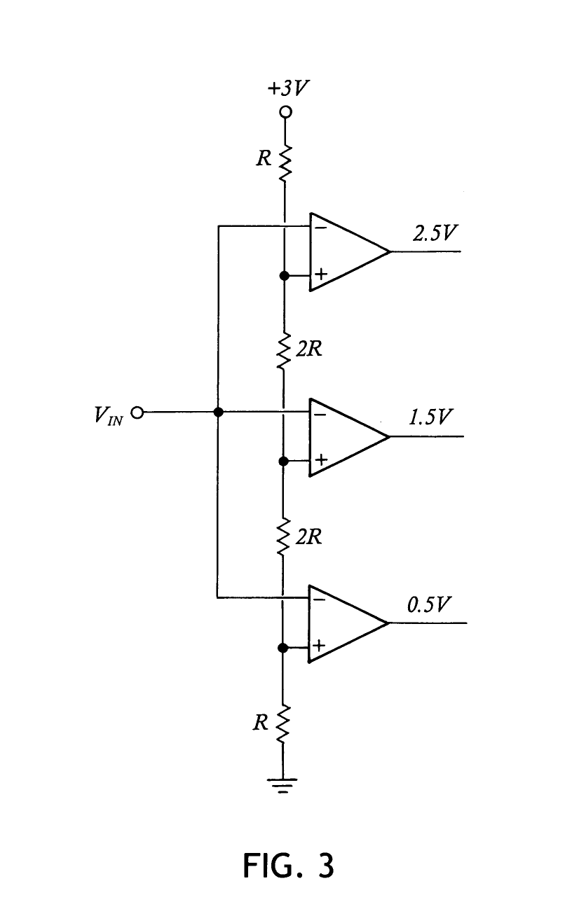

In some aspects, the control unit of the present invention includes an analog/digital converter. The analog/digital converter has the capability of receiving an analog signal from the sensor and converting it into a digital signal. A simplified version of a 2 bit flash analog/digital converter is shown in the FIG. 3. For exemplary purposes only, a suitable analog/digital converter can be an ADC 088S022 analog to digital converter manufactured by Analog Devices Inc. (having a place of business in Norwood, Mass., U.S.A.). In some aspects, the analog/digital converter may be an integral part of the processor, rather than a separate unit. In other aspects, the sensor may be a digital sensor which directly provides a digital signal to the data flow microcontroller processor so that analog to digital converter is optional and/or not employed.

The control unit of the present invention also includes a data flow microcontroller processor. Suitable processors include those which can receive a digital signal from a sensor or from an analog/digital converter, and which can control the flow of data associated with the digital signal. For example, one such suitable processor is a PIC 16F873, available from Microchip Technology Inc. (having a place of business in Chandler, Ariz., U.S.A.). In another example, the processor may be a personal computer where the processor is programmed to function as a data flow microcontroller processor. Alternatively, the processor may be a digital signal processor (DSP) chip such as TI-6713 manufactured by Texas Instruments, Inc (having a place of business in Dallas, Tex., U.S.A.).

Once the monitoring device has obtained the data signal from a particular instrument, it desirably communicates the information to a wireless transmitter. Such information can be provided in any desirable format, such as real time, periodic intervals, snapshots in time, time-averaged results, and the like. The monitoring device may be positioned in any suitable location with respect to the instrument, including near the instrument, on the surface of the instrument, inside of the instrument, and the like. In some desirable aspects, the monitoring device is electrically connected to the instrument. In particular aspects, the monitoring device is in the form of dedicated hardware for repeat uses. However, in other aspects, the device can be an inexpensive and/or disposable unit designed for a single use or a small number of repeat uses. Desirably, the monitoring device is located near or in the vicinity of the instrument. In some particular aspects, the monitoring device is attached or affixed to the instrument. Such attachment may or may not be permanent.

In some aspects, the system of the present invention is utilized in a healthcare setting. In some particular aspects, at least one monitoring device is configured to collect data relating to at least one healthcare instrument parameter. The monitoring device can be suitable for use inside of a healthcare facility where the healthcare instrument is located. In other aspects, the device can be suitable for use outside of the healthcare facility, depending largely on where the healthcare instrument is located. Desirably, the monitoring device is located near or in the vicinity of the healthcare instrument.

As referenced above, once the monitoring device has measured a particular parameter of an instrument, it can desirably transmit the information to a wireless transmitter. More particularly, the data flow microcontroller processor communicates the digital signal to a wireless transmitter. At least one wireless transmitter is associated with at least one instrument. However, one or more wireless transmitters may be associated with any particular instrument, and may be utilized when assessing the health of the instrument.

As a general principle, wireless transmitters which are utilized in aspects of the present systems and methods may be of any configuration. For example, the transmitter may be an active, semi-active, or passive wireless transmitter. Suitable wireless transmitters will typically include an antenna, and will be configured to transmit the data using a wireless transmission protocol. Accordingly, the wireless transmitter can convey the data signal via an antenna using a desired wireless protocol. One of ordinary skill in the art will appreciate that the wireless transmitter utilized in the present invention may be of any suitable size, shape, type, or origin so long as the reader and antenna are appropriately configured and otherwise compatible. For exemplary purposes only, one suitable wireless transmitter can be an XBeePro 24, manufactured by Digi International (having a place of business located in Minnetonka, Minn., U.S.A.).

Wireless communication can be achieved using various wireless transmission protocols. In some desirable aspects, the wireless transmission protocol is ZigBee. One advantage of ZigBee in this aspect of the invention is that it can form wireless networks between several units. As a result, it can transmit data over relatively long distances (as compared to Bluetooth, for example) since it can jump from one network to another.

More particularly, ZigBee technology is a wireless protocol which has been standardize through Zigbee Alliance. It is a set of specifications built around the IEEE 802.15.4 wireless protocol. ZigBee is particularly well-suited for low-power, low-cost, low data rate applications. ZigBee is designed to provide highly efficient connectivity between small packet devices. The ZigBee specifications support robust mesh networks that can contain hundreds of nodes. More particularly, ZigBee supports self-healing mesh networking which is a decentralized network topology very similar to the Internet. It allows nodes to find new routes through the network if one rout fails. Such networks permit messages to travel a number of different routes to get from one node to another, making a reliable network not dependent on any particular individual node to function. Examples include Mesh networks and Star networks.

As a result of its simplified operations, which are one to two full orders of magnitude less complex than a comparable Bluetooth device, pricing for ZigBee devices is extremely competitive, with full nodes available for a fraction of the cost of a Bluetooth node. ZigBee devices are actively limited to a through-rate of 250 Kbps, compared to Bluetooth's much larger pipeline of 1 Mbps, operating on the 2.4 GHz ISM band, which is available throughout most of the world. A typical range of operation for ZigBee devices is 250 feet (76m), substantially further than that used by Bluetooth capable devices. Due to its low power output, ZigBee devices can sustain themselves on a small battery for many months, or even years, making them ideal for install-and-forget purposes.

In addition to ZigBee, other wireless protocols may also be suitable for the present invention. Such protocols include, but are not limited to RFID technology (e.g., active RFID), 802.11b (Wi-Fi), 802.11a (Wi-Fi5), 802.11g, HomeRF, Wireless 1394, HiperLAN2, Ultrawide Band (UWB), and Bluetooth, as well as other protocols or systems to transmit the data to a central source. Each of these different standards has particular advantages and has been developed with particular applications and users in mind. In some instances, these standards are not compatible with one another and do not allow interoperability of wireless devices implementing these different standards.

Of these standards, 802.11b, 802.11g, HomeRF, Bluetooth (and Zigbee) operate over the 2.4 GHz unlicensed band. The IEEE 802.11b standard (Wi-Fi) provides wireless transmission of up to 11 Mbps of data at distances ranging up to 300 feet indoors to well over 1000 feet line-of-sight outdoors. The distance depends on impediments, materials, and line of sight. 802.11b is an extension of Ethernet to wireless communication. The standard is backward compatible to earlier specifications, known as 802.11, allowing speeds of 1, 2, 5.5 and 11 Mbps on the same transmitters. The 802.11g standard is a high rate Wi-Fi standard, allowing data rates above 22 Mbps. The standard requires orthogonal frequency division multiplexing (OFDM), which allows for data rates up to 54 Mbps. The standard also allows for the use of packet binary convolutional code (PBCC), which provides data rates up to 22 Mbps (later versions may be up to 33 Mbps), and complementary code keying-orthogonal frequency division multiplexing (CCK-OFDM), which provides data rates up to 33+ Mbps.

HomeRF initially provided data rates of only 2 Mbps, but have now been able to increase up to 10 Mbps. The primary advantage of HomeRF is the integration of voice and data into its baseline data transmission. As such, HomeRF hubs allow the use of cordless phone handsets as well as computers for transmitting data.

Two of the wireless standards introduced above operate over the 5 GHz band. These include 802.11a and the European HiperLAN2 standards. The IEEE 802.11a standard (Wi-Fi5) provides wireless transmission of up to 54 Mbps of data. While the Wi-Fi5 data rates are higher due to the higher frequency and greater bandwidth allotment, because the same power limits apply, Wi-Fi5 range is limited to only a few dozen feet. Hiperlan2 is in Europe and utilizes similar technologies as 802.11a. Indeed, the physical layers (PHYs) are almost identical. The main differences are at the media access control (MAC) layer. The 802.11a's MAC provides wireless Ethernet functionality and was extended to this band from the 802.11b's specification. In contrast, HiperLAN2 supports time critical services as well as asynchronous data. HiperLAN2 is compatible with various networks and includes transmit power control and dynamic frequency selection, which should provide greater spectrum efficiency and lower interference with other systems operating on 5 GHz.

The terms “ultra wideband” (UWB) and “digital pulse wireless” refer to Radio Frequency (RF) devices that operate by employing very narrow or short duration pulses resulting in very large or “wideband” transmission bandwidths. As defined by the Federal Communications Commission (FCC), the bandwidth of UWB systems is more than 25% of a center frequency or more than 1.5 GHz. UWB is typically implemented in a carrierless fashion. As compared to conventional narrowband and wideband systems using RF carriers to move the signal in the frequency domain from baseband to the actual carrier frequency where the system is allowed to operate, UWB implementations directly modulate an “impulse” that has a sharp precise rise and fall time, thus resulting in a waveform that occupies several GHz of bandwidth.

Bluetooth is the name of a wireless technology standard for connecting devices, set to replace cables. It uses radio frequencies in the 2.45 GHz range to transmit information over short distances of generally 33 feet (10 meters) or less. Bluetooth creates a personal-area network (PAN) and the user is not required to do anything special to get the devices to speak to one another. They operate in a perpetual interactive mode by default. The maximum bandwidth for any single channel or frequency is 1 megabyte per second (1 Mbps), while individual packets range up to 2,745 bits. There are currently three classifications of Bluetooth devices, relative to transmitting range—Class 1: 1 milliwatt Up to 33 feet (10 meters); Class 2: 10 milliwatts Up to 33 feet (10 meters); and Class 3: 100 milliwatts Up to 328 feet (100 meters). As the range is increased the signal used in the respective classification is also stronger.

The data signal transmitted by the wireless transmitter of the present invention is received by a wireless reader. Suitable wireless readers will typically include an antenna, and will be configured to be compatible with the wireless transmission protocol. Accordingly, the wireless reader can receive and read the data signal transmitted by the wireless transmitter. One of ordinary skill in the art will appreciate that the wireless reader utilized in the present invention may be of any suitable size, shape, type, or origin so long as the reader and antenna are appropriately configured and otherwise compatible with the wireless transmitter and wireless transmission protocol. By way of example, suitable wireless readers can include any reader module or combination of modules that support the type or types of wireless transmitters and wireless transmission protocols used with the system. For instance, in some aspects, a suitable reader could include an XBeePro 24, manufactured by Digi International. In other aspects, suitable readers could include those that support EPC Generation 2 protocol, such as a Thingmagic Mercury 4e/h reader, available from Thingmagic, Inc. (having a place of business in Cambridge, Mass., U.S.A.).

Once received by the wireless reader, the data is transferred to a computing device that is in communication with the wireless reader. Any computing device may be suitable, provided it can communicate with the wireless reader, and can receive and recognize the data transmitted by the reader. In some desirable aspects, the computing device includes software capable of presenting the data signal as user-readable data. In further aspects, the software is also capable of analyzing the data. Suitable software will be dependant upon the analysis desired by the user. By way of example only, software such as Visual Basic 6, developed by Microsoft Inc (having a place of business in Seattle, Wash., U.S.A.) could be utilized to develop a specific software application and generate a response model based on the data analysis. The software may also have capabilities of database management and monitoring of a continuous stream of data transferred from the sensor into a data base. The response model of such software may be based on monitoring each data point over a period of time and indicating a response based on a preset threshold value.

In some aspects of the present invention, the system also includes a computer-readable storage medium in communication with the computing device. The computer-readable storage medium is capable of storing the data. By way of example only, one suitable computer-readable storage medium includes a 25LC1024-I/MF, 1 Mega Byte EEPROM manufactured by Microchip Technology (having a place of business located in Chandler, Ariz., U.S.A.

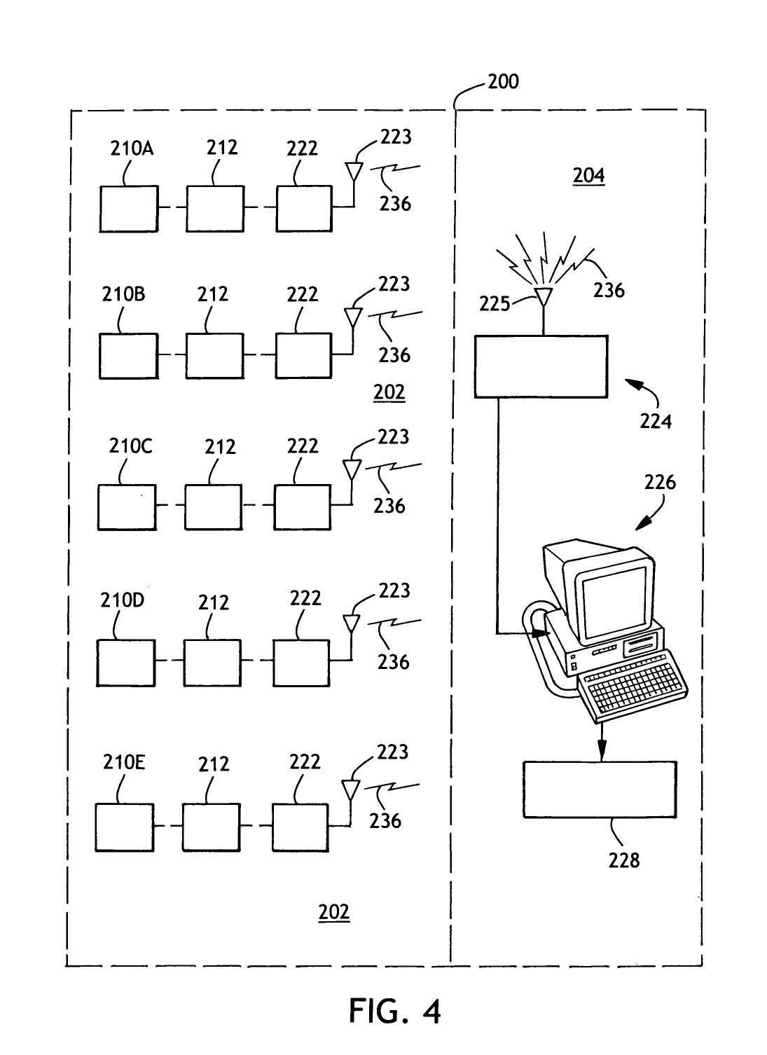

In some aspects, the system can measure a single instrument. In other aspects, the system of the present invention can measure multiple instruments, the data of which can be transmitted to a single computing device. FIG. 4 illustrates an exemplary system of the present invention which can measure multiple instruments. In this exemplary system 200, multiple instruments 210A-E, such as healthcare instruments for example, located in a first location 202 are each measured by a monitoring device 212. Data from each monitoring device 212 is communicated to corresponding wireless transmitters 222, and the data signal 236 from each is wirelessly transmitted via an antenna 223 using a wireless transmission protocol, such as ZigBee for example. A single wireless reader 224 located in a second location 204 reads the data via an antenna 225 which receives the data signals 236 transmitted by the wireless transmitters 222. The data signal is then communicated to a single computing device 226 for processing via software. If desired, the data can be stored on a computer-readable storage medium 228 for logging purposes and/or for potential further analysis, such as by comparing with existing data on the storage medium 228, or with future data.

In some aspects of the present invention, the collected data can be tied to scheduling of procedures or other activities involving the tracked instruments. For example, in a hospital setting for instance, before a doctor begins a surgery, he or she can use the system or method of the present invention to ensure that an instrument is selected which has adequate battery life, proper calibration, proper maintenance, and the like, for the medical procedure about to be performed. Rescheduling may be needed if suitable resources are not available. Preferably, however, the schedule would be correlated with an instrument's health or status to ensure that any further preparation (e.g., calibration, maintenance, recharging) is completed prior to performing the medical procedure, or to ensure that a backup power source or additional instruments are available if needed.

In addition, other parameters such as time of last use, total time of use, and the like, can also be tracked with the present system and method. The computerized system for tracking the status of power source as well as calibration and maintenance of instruments can be used to improve relationships with insurers and possibly reduce rates, or be used as a selling point for a healthcare facility as a whole. For example, it may help patients/residents understand that they are more likely to receive good care at a particular facility because of the benefits which result from using the present invention. In certain situations, the present invention could be utilized to identify the use frequency of instruments, allowing reconsideration of equipment needs.

In some aspects, the system and method of the present invention further comprise defining a response model, with the response model specifying at least one action to be implemented when a discrepancy arises between the incoming information and that of a historical or baseline database. For example, the action item may be determined by cross-referencing the instrument parameter data received from one or more wireless transmitters with stored data in the computer-readable storage medium. Alternatively or additionally, the action item may be determined based on analysis by software capable of analyzing the information as utilized by the computing device.

In some aspects, the system and method of the present invention further comprise sending at least one signal to implement the at least one action. Actions taken in response to the signal can include sounding an audible alarm and/or sending a pre-determined message via a communication system, such as the computing device, a telephone, the Internet, a facsimile, an e-mail, a text message, a pager, and the like. Other actions include disengaging (or engaging) the instrument, or de-energizing an electrical circuit, such as by energizing or de-energizing a relay to interrupt the flow of electrical current to an instrument. The response model may provide that alarms are combined, changed, and escalated in intensity based on responses (or lack thereof) and additional sensor data.

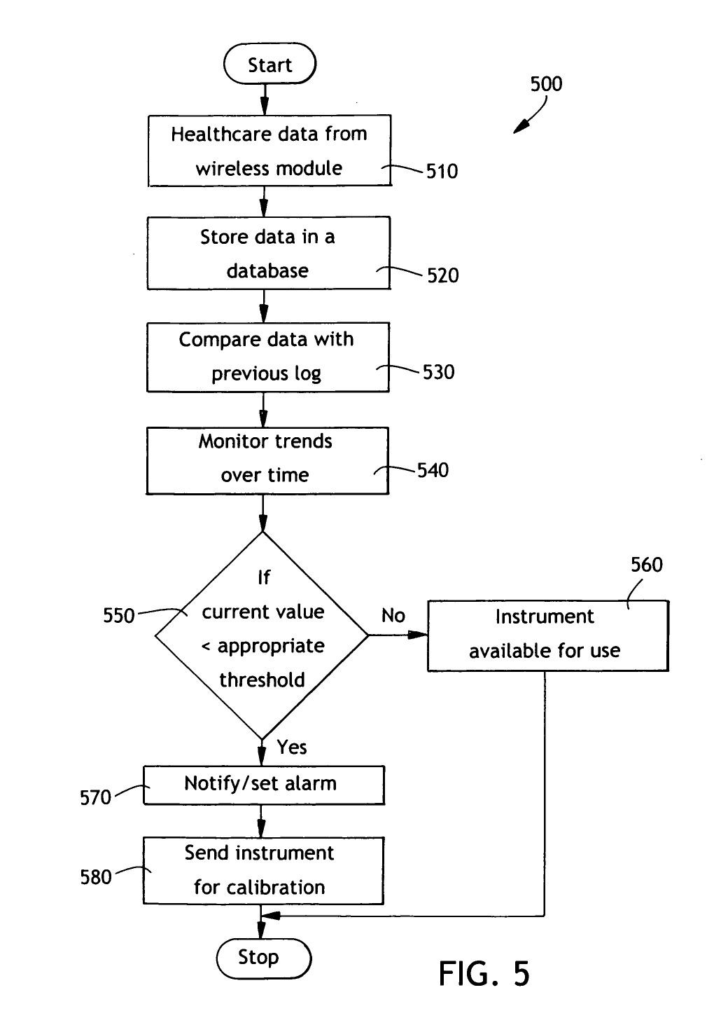

FIG. 5 is a flow diagram of one exemplary, non-limiting, response model 500 directed to a healthcare setting. Healthcare instrument calibration data is received from a wireless transmitter at 510, and the data is stored in a database at 520. The data is then compared with previous data stored in the database at 530 and calibration or operational trends over time are discerned at 540. The response model analyzes the data at 550 to determine whether the calibration falls above or below a particular threshold value. In this example, if the data is at or above the threshold value, the response model 500 determines that the instrument is available for use at 560 and no further action is taken. If the data falls below the threshold value, the response model 500 notifies the user and/or sets an alarm at 570, and the healthcare instrument is tagged for calibration and/or other maintenance prior to further use at 580.

The response model may be further configured to define actions based on sensor data from one or more secondary sensors or alarm systems. For example, the secondary alarm systems or additional sensors may detect the scheduling of a particular instrument, or removal of the instrument from or into a particular location, such as by motion detector or by photo detector. A secondary alarm system may detect the opening of a cabinet or door, or may include a motion sensor.

In some aspects, it may be desirable to determine the location of a particular instrument. For example, the signal from the monitoring device may be correlated to the identity of the instrument. Accordingly, the invention may additionally include a proximity detection system having the capability of determining the location of a particular instrument. This can be helpful when identifying an instrument which requires attention, or to identify instruments for use scheduling. In some instances, the ability to quickly identify the location of a particular instrument may be essential, such as in the case of an emergency.

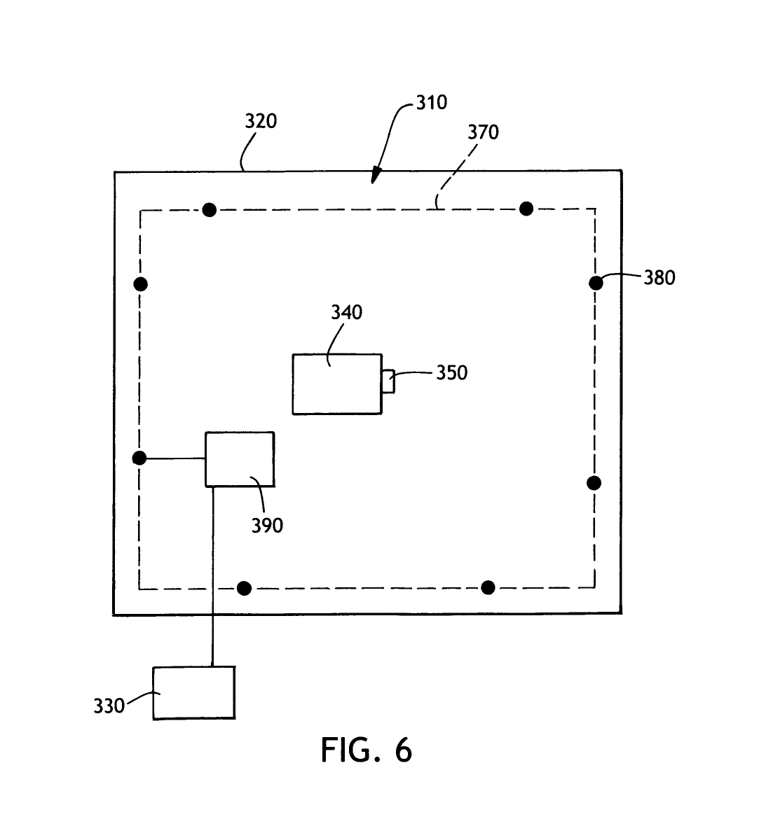

In some aspects, proximity may be sensed by a proximity detection system. The proximity detection system may include, by way of example only, any suitable combination of RFID reader module and antenna. It is understood that other wireless transmission protocols, such as those described above, can also be suitable. For exemplary purposes only, a proximity detection system is illustrated in FIG. 6. Referring to FIG. 6, a proximity detection system 310 includes an RFID transmitter 350 associated with a particular instrument 340. A at least one, or a plurality of, RFID sensors 390 can be placed in strategic areas within a facility, such as in a particular room 320 to establish a perimeter 370 in an area around the instrument 340. The perimeter is established in this example by a plurality of antennas 380 which are connected to a respective detector 390. For instance, if UHF RFID tags are utilized as the transmitter, the antenna may comprise a circularly polarized patch antenna operating at frequencies including the UHF frequency band (902-236 MHz). However, antenna arrangement and placement may be varied without departing from the spirit and the scope of the present technology.

Detectors 390 are configured to detect when an instrument 340 associated with an RFID tag 350 enters a perimeter 370 by reading the RFID tag 350 associated with each instrument 340. The tag or tags may be located on or by each instrument and/or may be integrated into the instrument. By way of example, suitable detectors include any RFID reader module or combination of modules that support the type or types of RFID tags used with the system. For instance, suitable readers could include any reader that supports EPC Generation 2 protocol, such as the Thingmagic Mercury 4e/h reader, available from Thingmagic, Inc. of Cambridge, Mass. One of skill in the art will appreciate that the RFID reader(s) and antenna(s) utilized in association with the present subject matter may be of any suitable size, shape, type, or origin so long as the reader(s), antenna(s), and tag(s) are appropriately configured and otherwise compatible.

The RFID detector 390 can detect the proximity of the instrument 340 based on the strength of reception of the signal from the transmitter 350. The resulting proximity information can then be transferred to a computing module 330, which can provide proximity information to the user. For example, based on data obtained from the detectors and one or more predefined response models, various actions may be taken to alert users as to the location of a particular instrument. For example, the proximity information may be transmitted to the computing device of the present invention to be included with instrument parameter data provided by the instrument monitoring system of the present invention. However, any number and combination of suitable actions may be defined in a response model and implemented using appropriate hardware and software.

It will be appreciated that details of the foregoing examples, given for purposes of illustration, are not to be construed as limiting the scope of this invention. Although only a few exemplary embodiments of this invention have been described in detail above, those skilled in the art will readily appreciate that many modifications are possible in the examples without materially departing from the novel teachings and advantages of this invention. For example, features described in relation to one example may be incorporated into any other example of the invention.

Accordingly, all such modifications are intended to be included within the scope of this invention, which is defined in the following claims and all equivalents thereto. Further, it is recognized that many embodiments may be conceived that do not achieve all of the advantages of some embodiments, particularly of the desirable embodiments, yet the absence of a particular advantage shall not be construed to necessarily mean that such an embodiment is outside the scope of the present invention. As various changes could be made in the above constructions without departing from the scope of the invention, it is intended that all matter contained in the above description shall be interpreted as illustrative and not in a limiting sense.

What is claimed is:

1. An instrument monitoring system comprising:
a monitoring device comprising a sensor for measuring an instrument and a control unit, wherein the control unit includes a data flow microcontroller processor;
a wireless transmitter configured to receive a data signal from the monitoring device and to transmit the data signal using a wireless data transmission protocol;
a wireless reader capable of receiving the data signal from the wireless transmitter;
a computing device in communication with the wireless reader, wherein the computing device includes software configured to present the data signal as user-readable data; and
a computer-readable storage medium in communication with the computing device, wherein the computer-readable storage medium is capable of storing the data.

2. The system of claim 1 wherein the control unit further includes an analog/digital converter.

3. The system of claim 1 wherein the monitoring device is attached to the instrument.

4. The system of claim 1 wherein the monitoring device is configured to measure at least one instrument parameter.

5. The system of claim 1 wherein the computing device is configured to execute instructions embodied in the computer-readable storage medium based on a response model.

6. The system of claim 1 further comprising a proximity detection system capable of determining the location of the instrument.

7. The system of claim 1 comprising multiple monitoring devices and a single computing device.

8. The system of claim 1 wherein the instrument is a healthcare instrument.

9. The system of claim 1 wherein the data relates to an instrument parameter.

10. The system of claim 9 wherein the instrument parameter is a healthcare instrument parameter.

11. The system of claim 9 wherein the instrument parameter does not include battery health.

12. The system of claim 1 wherein the wireless transmission protocol is Zigbee.

13. The system of claim 1 wherein the software is capable of analyzing the data.

14. The system of claim 1 wherein the wireless transmitter includes an antenna.

15. The system of claim 1 wherein the wireless reader includes an antenna.

16. A healthcare instrument monitoring system comprising:
a monitoring device comprising a sensor and a control unit, wherein the sensor is configured to collect information relating to at least one healthcare instrument parameter, wherein the control unit comprises an analog/digital converter in communication with the sensor configured to convert an analog signal from the sensor to a digital signal, and wherein the control unit further comprises a data flow microcontroller processor in communication with the analog/digital converter configured to control the flow of the data signal;
a wireless transmitter configured to receive the data signal from the monitoring device and to transmit the data signal using a wireless data transmission protocol;
a wireless reader capable of receiving and reading the data signal from the wireless transmitter;
a computing device in communication with the wireless reader, wherein the computing device includes software capable of presenting the data signal as user-readable data; and
a computer-readable storage medium in communication with the computing device capable of storing data, wherein the computing device can access the data stored onto the computer-readable storage medium.

17. The system of claim 16 wherein the software is capable of analyzing the data.

18. The system of claim 16 further comprising a response model.

19. A method for monitoring a healthcare instrument comprising:
(a) providing a monitoring device configured to collect data relating to at least one parameter of a healthcare instrument;
(b) Connecting the monitoring device to the healthcare instrument to obtain an instrument parameter data signal;
(c) Transferring the data signal from the monitoring device to a wireless transmitter;
(d) Wirelessly transmitting the data signal from the wireless transmitter to a wireless reader using a wireless transmission protocol;
(e) Transferring the data signal from the wireless reader to a computing device comprising software capable of analyzing the data signal;
(f) Analyzing the data signal to provide analyzed data;
(g) Performing an action based on the analyzed data using a response model; and
(h) Updating the instrument parameter in a database stored on a computer-readable storage medium.

20. The method of claim 19 further comprising comparing the analyzed data to a historical database.

21. The method of claim 19 wherein the wireless transmission protocol is ZigBee.

22. The method of claim 19 further including detecting the proximity of the healthcare instrument.
